(19) United States
(12) Patent Application Publication
(10) Pub. No.: US 2015/0295326 A1
(43) Pub. Date: Oct. 15, 2015

(54) ANTENNA APPARATUS AND SOFTWARE FOR EMULATING SAME

(71) Applicant: Christopher Sterling, Oklahoma City, OK (US)

(72) Inventor: Christopher Sterling, Oklahoma City, OK (US)

(21) Appl. No.: 14/591,019

(22) Filed: Jan. 7, 2015

Related U.S. Application Data
(60) Provisional application No. 61/925,808, filed on Jan. 10, 2014.

(51) Int. Cl. H01Q 21/00; G06T 11/60; H01Q 1/36

(52) U.S. Cl. CPC H01Q 21/00; H01Q 1/36; G06T 11/60

(57) ABSTRACT

According to an embodiment, there is provided a plurality of spiral antenna elements that are generated using algorithms taught herein that can be implemented in hardware or software. Embodiments utilize symmetric combinations of 2 or 3 such spiral elements on a substrate or within computer memory to create an array. Each of the antenna elements is in the form of expanding spiral (non-logarithmically expanding) and contains at least six turns. Among the suitable spirals are Fermat, and/or Cornu (Euler) and/or Archimedes and/or other non-logarithmically expanding spirals in any combination. As an article of manufacture, the antenna array may be incorporated into a chip, such as might be found in a cell phone or other CPU based product, or printed or otherwise mounted on an article of clothing, for example.

### CROSS REFERENCE TO RELATED APPLICATION

This application claims the benefit of U.S. Provisional Application No. 61/925,808 filed Jan. 10, 2014, herein incorporated by reference in its entirety for all purposes.

### FIELD OF THE INVENTION

This invention relates to antennas and, in particular, to arrays of radiating and receiving spiral elements used in combination with other components and articles of manufacture using the same.

### BACKGROUND

Electromagnetic field (EMF) radiation (sometimes called radio frequency radiation) of the sort emitted by a wide variety of modern electronic components has been associated with numerous types of health problems in humans (e.g., inflammation, decreased oxygenation, reduced stamina and endurance, agitated nervous system, muscle tension, spasms, cramping, headaches and migraine pains, or decreased digestive function, etc.). With respect to low intensity EMF radiation, it is now broadly acknowledged that even low intensity EMF radiation interacts with environmental and biological variables which raises immediate concerns that there might be unforeseen negative biological consequences of such exposure. As a consequence, there has been an increasing research focus in recent years aimed toward understanding the effects of short and long term exposure to such radiation might have on the individuals who are exposed to it. Whatever its impact, there is mounting evidence that EMF radiation has a measurable impact on the human body and other organisms.

Heretofore, as is well known in the EMF radiation arts there has been a need for an invention to address and solve the disadvantages of prior art methods of attenuating same. Accordingly it should now be recognized, as was recognized by the present inventors, that there exists, and has existed for some time, a very real need for a system and method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of the invention within the ambit of the appended claims.

### SUMMARY OF THE INVENTION

According to a first aspect, there is provided herein an antenna apparatus. In an embodiment, some number of antenna elements in the form of Archimedes spirals will be arranged in symmetric combinations of two or three such spirals to form the conductive portion of an antenna apparatus. In other embodiments, the Archimedes antenna elements will be combined with a plurality of Fermat's (double) spiral elements to form the conductive portion of the antenna apparatus. The spirals will be then placed on an appropriate substrate for use as an antenna and situated spatially as described hereinafter. In each case, the spirals will be comprised of at least three or more turns, but preferably 6 turns.

In another embodiment, some number of Archimedes spirals will be combined with a plurality of Cornu (double end Euler or “S”) spirals to form the conductive portion of an antenna apparatus, with the conductive portion being placed on an appropriate substrate. In other embodiments, the Cornu antenna elements will be used alone in symmetric combinations of two or three such spirals to form the conductive portion of an antenna apparatus. In each case, the spirals will be comprised of at least three turns, but preferably six.

In a further embodiment, some number of Fermat and/or Cornu spirals will be used in combination to form the conductive portion of the antenna apparatus, with the spirals so used being placed on an appropriate non-conducting substrate according to the placement described hereinafter. In each case, the spirals will be comprised of three or more turns, but preferably six.

Finally, according to an embodiment an antenna element will be formed from a spiral that expands non-logarithmically. In each case, the spirals will be comprised of at least three, but preferably six, turns.

According to still another aspect, there is provided a software program and associated algorithms for producing in software a simulated array substantially similar to one or more of those disclosed herein as hardware. In the text that follows, it should be understood that when “hardware” patterns are described the same patterns are intended to be used in this embodiment of the as being displayed on a video screen or otherwise calculated and stored in video or other memory. In each case, the spirals will be comprised of at least three turns, but preferably six turns.

In a further embodiment, an antenna array is simulated using algorithms set forth herein. As discussed below, some number N of non-logarithmic spirals of the sort described below (preferably where N=1 or N=2x or N=3x, x being a positive integer) will be placed in a spaced apart location on a substrate or simulated within a computer that preferable has a display integral thereto. As an article of manufacture, the antenna array disclosed herein may be incorporated into any electronic or electrical device. As a method, it may be implemented within any programmable device.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a top plan view of one embodiment of a hardware component of an antenna element;

FIG. 2 is a plan view of an antenna element suitable for use with the instant invention;

FIG. 3 contains various embodiments of antenna elements suitable for use with the instant invention;

FIG. 4 contains a schematic representation of a version of an Archimedes spiral which could be an antenna element according to the instant invention;

FIG. 5 contains a schematic illustration of a cell phone with an embodiment of the invention active thereon;

FIG. 6 contains an embodiment of a collection of antenna elements arranged as an array according to the teachings herein;

FIG. 7 contains an embodiment of a collection of antenna elements arranged as an array according to the teachings herein;

FIG. 8 contains an embodiment of a collection of antenna elements arranged as an array according to the teachings herein; and

FIG. 9 contains a schematic illustration of an embodiment of an array according to the instant invention as it might be used in practice;

FIGS. 10A-10C contain illustrate actual photomicrographs of blood cells before and during exposure to EMF radiation, and with and without activation of an embodiment of the instant invention.

FIG. 11 indicates an operating logic suitable for use with the instant invention.

FIG. 12 contains an embodiment of a collection of antenna elements arranged as an array according to the teachings herein.

FIG. 13 contains a schematic illustration of an embodiment of an array of elements according to the instant invention as it might be used in practice on a desktop computer.

FIG. 14 contains a schematic illustration of how turns are calculated according to an embodiment.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

Turning now to the various figures herein, it should be noted as an initial matter that, although the various hardware configurations are discussed in figures attached hereto, the focus of the instant invention is reproduction of the patterns as set out below as antenna elements and/or on the screen of any computer device having such, and/or writing to memory the patterns described hereinafter. In each case, the instant inventor believes such would have the same or a comparable effect as preparing one of the hardware embodiments below.

By way of general explanation to the discussion that follows, the photon is the elementary particle responsible for electromagnetic phenomena. It is the carrier of electromagnetic radiation of all wavelengths, including gamma rays, xrays, ultraviolet light, visible light, infrared light, microwave, and radio waves. The photon differs though from many other elementary particles such as the electron and the quark, in that it has zero rest mass, therefore, it travels in a vacuum at the speed of light. Like all quanta, the photon has a wave, spin, and particle properties. They also have the ability to carry the “frequency” and “intensity” from the last source they were associated with. So the photon can carry the antenna array through a device to keep the person's/or aerobic organism's electromagnetic biofield coherent within the wavelength distances of the electronic or electrical devise the array is applied to.

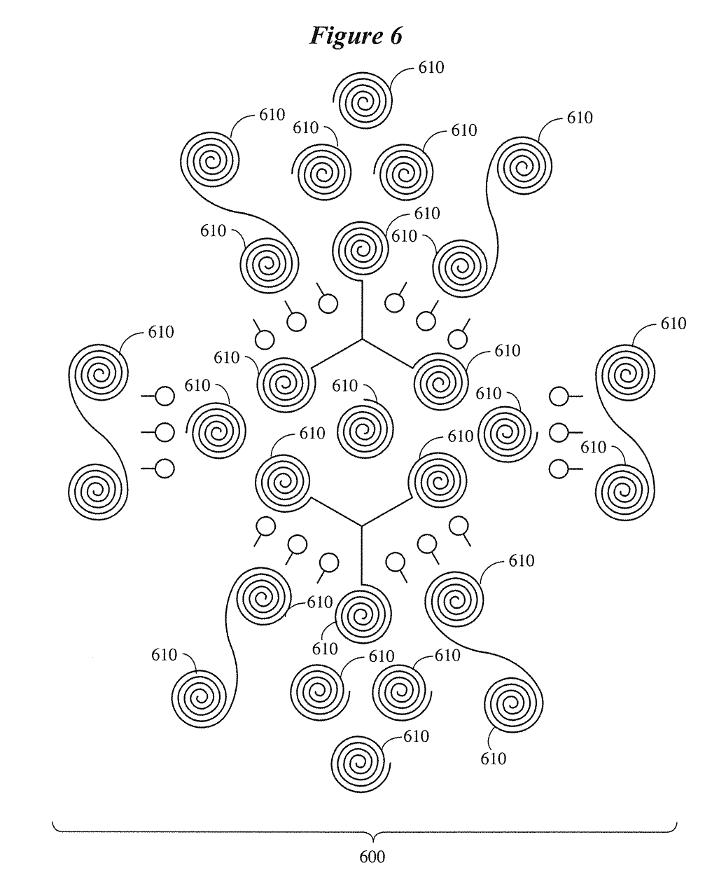

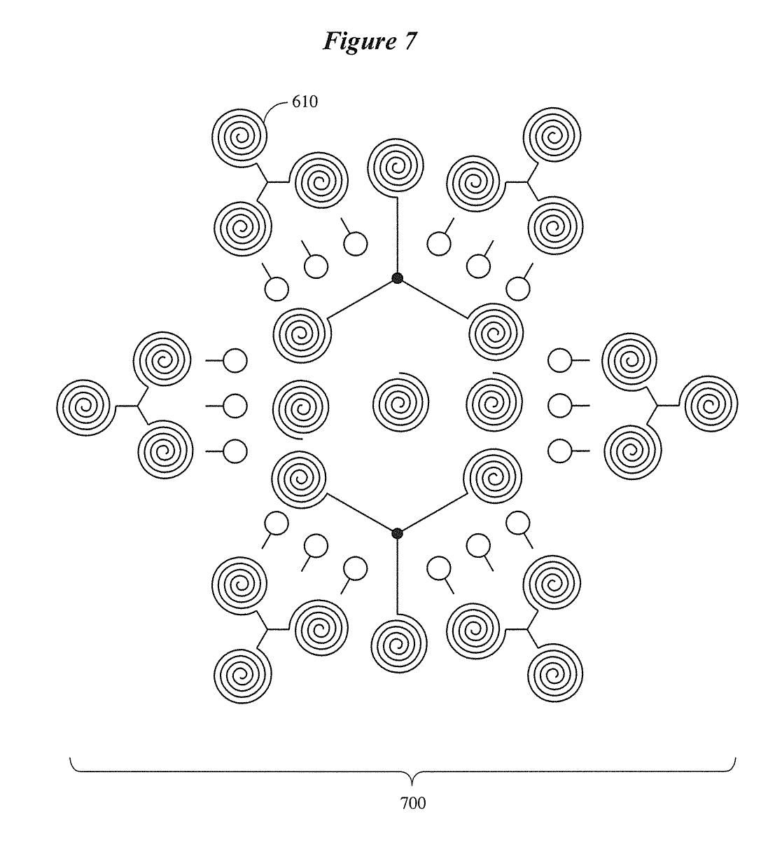

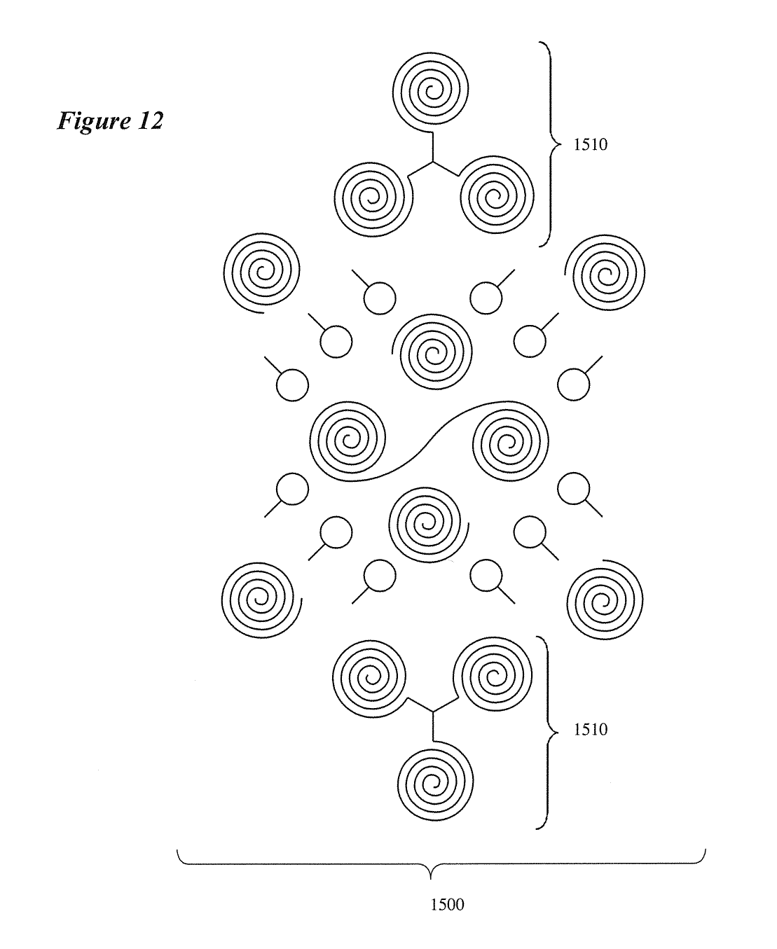

Turning now to a discussion of certain embodiments of the invention, referring initially to FIG. 5, the icon 510 contained there will be interpreted throughout the instant disclosure as any combination of the spirals 14, 200, 210, 300, 325, 350, or other non-logarithmically expanding spirals that are configured as an antenna element according to the rules discussed below. Said another way, this icon 500 should be broadly interpreted to represent combinations of the embodiments of FIGS. 1, 2 and 3. In some embodiments, the icon 500 will be used to represent the entirety of the patterns such as those set out in FIGS. 6-8 (i.e., array elements that are positioned according to the configurations 600, 700, and 800). FIG. 5 contains a schematic drawing of the icon 510 as it might appear when used in conjunction with a cellular telephone 500. FIG. 13 contains an example of a desktop computer 1300 that has been outfitted with an antenna 1310 that has been created according to rules discussed below.

Next turning FIG. 1, therein is depicted an antenna array that is schematically illustrated and generally designated as element 10. The antenna array 10 includes a substrate 12 having an antenna element 14 disposed thereon, which comprises a substantially continuous transducer arranged as an outwardly non-logarithmically expanding spiral of the sort defined below. It is important, though, that the array element of this embodiment has at least three turns, but preferably six turns therein. The spiral may be oriented in either direction (clockwise or counter clockwise).

In one embodiment, the outwardly expanding generally spiral antenna element shape can be represented as a Fermat's Spiral which may be written (in polar coordinates) as:

r²=a²θ.

where r is a distance from the origin, θ is an angle of rotation, and a is an arbitrary constant. In some embodiments six turns of the spiral will be used, i.e., 0≦θ≦2160° (e.g., FIG. 1). Other embodiments might use a different number of turns greater than 3, but 6 is the preferred number.

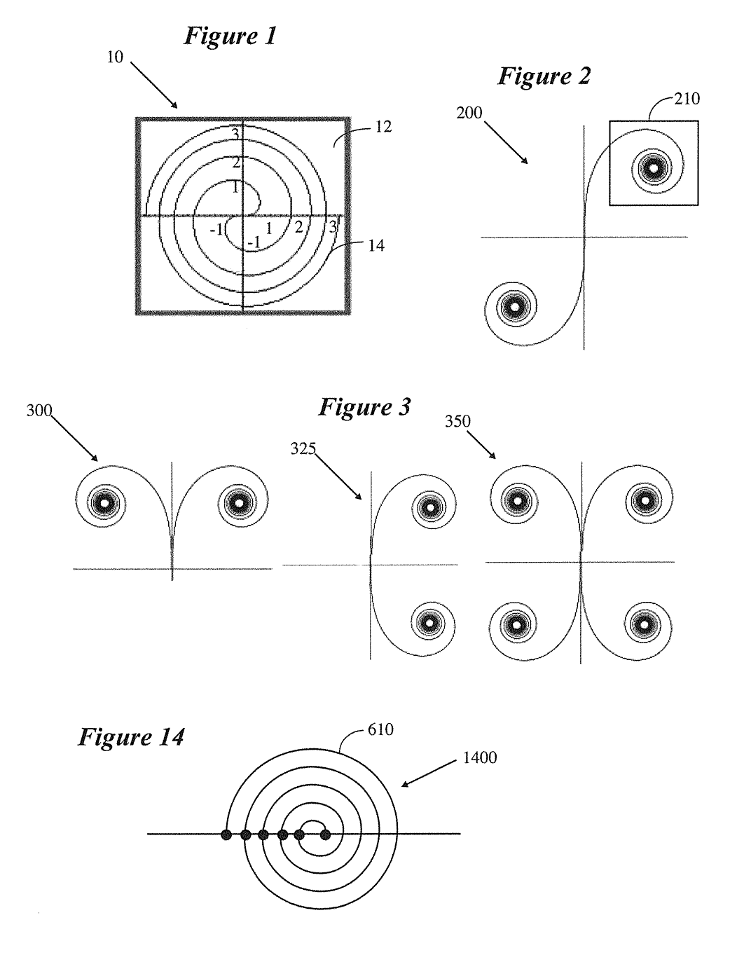

According to another embodiment, a double-ended spiral of Cornu (also known as the clothoid or Euler's spiral) might be used (FIG. 2 and various of the variations of FIG. 2 in FIG. 3). One set of defining equations for such a curve is:

$$x = + {\int }_{0}^{A} cos ( \frac{π}{2} {s}^{2} ) d s$$

$$y = - {\int }_{0}^{A} sin ( \frac{π}{2} {s}^{2} ) d s ,$$

where A is the length of the curve as measured from the origin. This curve has the property that its curvature grows with the distance from the origin. In an embodiment, “A” will be chosen such that the resulting figure has at least 3 turns on each end, but preferably 6. Note also that, in some embodiments, only a portion of this equation might be used, e.g., the portion of the spiral contained within box 210. It should be noted and remembered, that one of ordinary skill in the art will recognize that constant values might be multiplied by each of the forgoing to scale such to the particular array that is being constructed.

Note that the embodiment of FIG. 2 may be modified in any number of ways. FIG. 3 contains some specific examples. Obviously, the number of different curves that might appear (2, 3, 4, etc.) is a design decision that might be varied according to the particular circumstances.

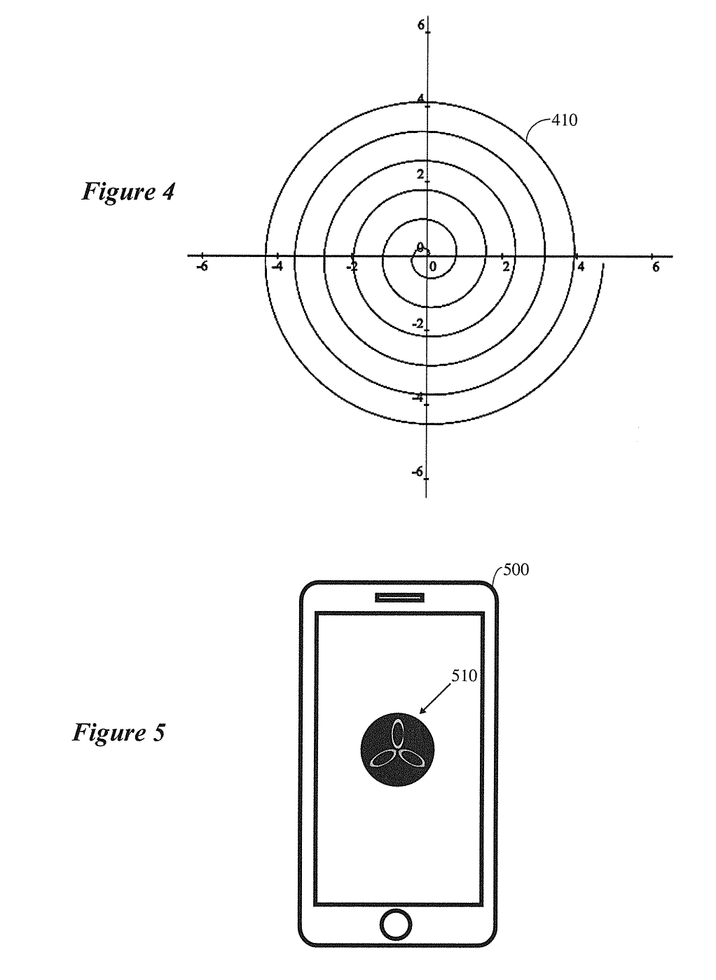

According to another embodiment, there is provided another array element as set out schematically in FIG. 4. FIG. 4 contains a representation of an Archimedes spiral antenna element 410 as it would appear when written in polar coordinates. Conventionally, this antenna element is represented by the equation r=aθ, where a is an arbitrary constant.

According to some embodiments the curve/array element might be expressed in three dimensions. More particularly, it should be appreciated that the arrays discussed herein might not be expressed in a plane but, instead, might be three dimensional shapes, e.g., r=azθ, where the variable “z” corresponds to a vertical/orthogonal direction with respect to the (r, θ) plane. This is just one example of how a 3D version might be created from the various 2D representations included herein. Of course, higher multidimensional shapes could certainly be designed by those of ordinary skill in the art according to the equations and other rules/constraints presented herein. Those of ordinary skill in the art will readily be able to devise other approaches to arranging the array elements.

In some embodiments, there may be multiple array elements 500 clustered in various combinations of two or three such elements. FIGS. 6-8 and 12 illustrate plan views of some embodiments of this sort. Note that the spirals used in these particular examples are generic in the sense that it is anticipated that in some embodiments various ones of those presented in FIGS. 1 through 3 inclusive should be substituted for those in the illustration. For example, with respect to FIG. 6, the spirals 610 of that figure are intended to be generally representative of any combination of the nonlogarithmically expanding spirals discussed previously. It is not required that every one of the spirals 610 be the same size or take the same functional form. Thus, for purposes of the instant disclosure when a spiral of the general form 610 appears in a figure it should be understood that it is a just “placeholder”.

Further with respect to FIGS. 6-8, as can be seen, the some number of the antenna elements occur in groups of three and that they be arranged symmetrically, and preferably arranged symmetrically with respect to both the “X” and “Y” axes. Further, in some embodiments the array elements will occur in multiples of 2 (e.g., 2, 4, 6, 8, etc). Additionally, it is preferred that in some embodiments clusters of basic 6-turn elements should also be included in multiples of three (e.g., there are six such clusters in FIG. 6). In certain embodiments, the groups of elements might be arranged at angles of 45°, 60°, 90°, 120°, etc., with respect to each other as is generally indicated generally in the figures. Other variations are within the teachings of the present invention.

With respect to FIG. 12, this drawing illustrates how it might be possible to construct an array 1500 where the number of spirals is equal to a multiple of 2, i.e., in the embodiment of FIG. 12 fourteen spirals are used. It is preferred that in some embodiments there also be at least one group of three spirals (1510)

In some embodiments an antenna element will be made of copper or any other electrically conductive metallic, nonmetallic, or organic, or nonorganic material (e.g., carbon, gold copper, silver, aluminum, etc.). In some embodiments it will act as a photonic or other transducer, converting low intensity EMF radiation into electrical or other energy.

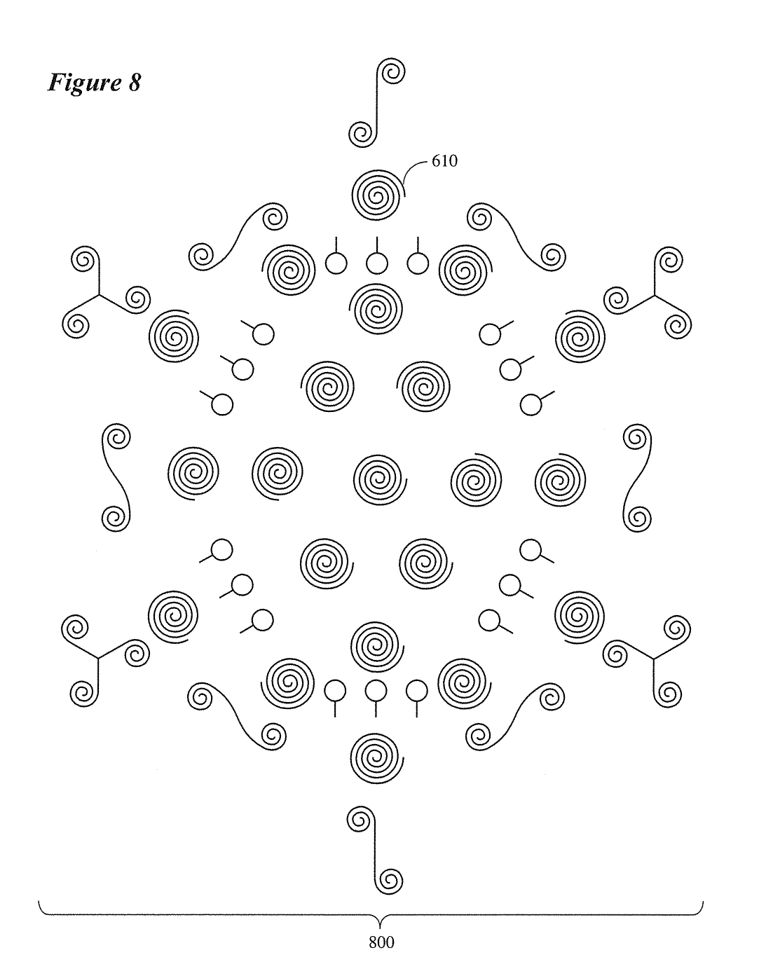

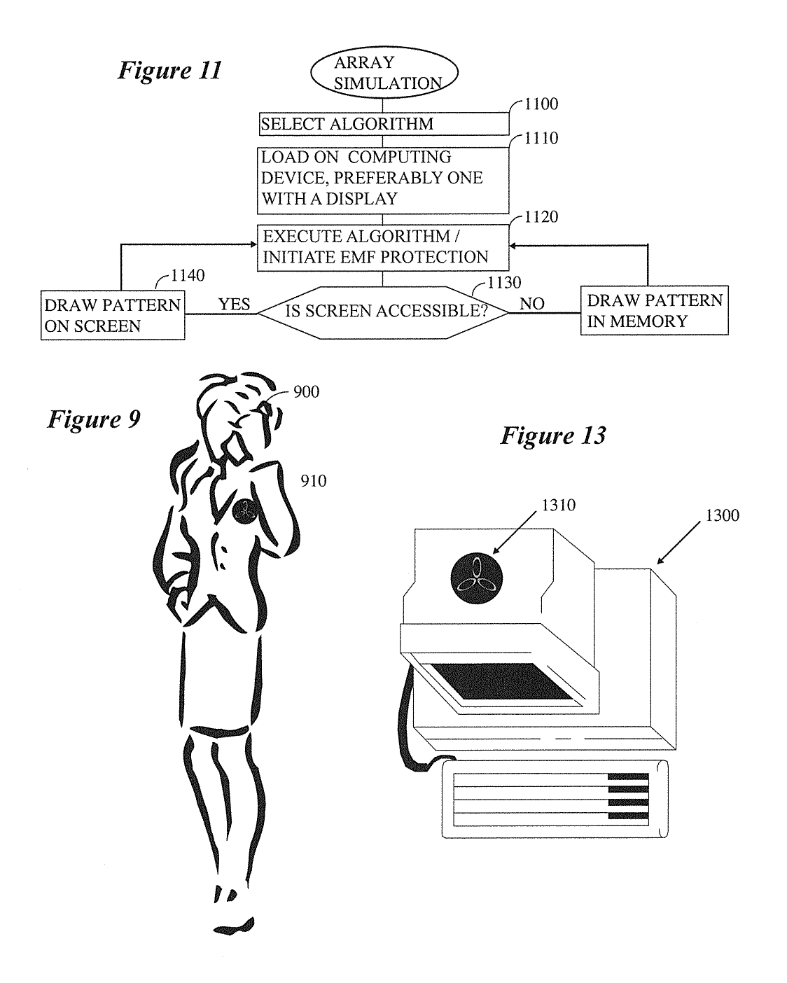

According to an embodiment, the instant invention is designed to mitigate the impact of low-intensity EMF radiation on an individual who wears or carries same in the presence of an EMF field, which may be referred to as biofield hereinafter. In FIG. 9, the biofield of the individual would be negatively impacted by EMF radiation from the cellular telephone absent the presence of an embodiment of the antenna 500 that has been situated on the individual's clothing. That being said, a cellular telephone is just one example of a source that continuously emits low level EMF radiation. As such, it should be noted that an embodiment of the instant array might be affixed to or made a part of a natural or manufactured emitting source (e.g., FIG. 5) or placed on the object that is to be protected (FIG. 13).

Turning again to FIG. 5, there is provided an example of how the instant invention might appear as implemented on a smart cellular phone. As is indicated, in one embodiment the algorithm will write a representation of a simulated array of the sort described above to the screen of the phone, thereby providing the user with the benefits of the instant invention during such time as that screen is displayed. As has been noted previously, the icon 500 is intended to generically represent any combination of the spiral forms taught herein. Thus, its appearance in various of the figures herein should be broadly understood to be indicative of the presence of individual ones, or multiple ones, of the spirals and other shapes according to the rules of various embodiments described previously.

In another embodiment, though, it should be noted that if the screen is not accessible to the instant program because, for example, it is being used for some other purpose or the display is currently turned off, it would be possible to write this simulated array to memory in a location so as to achieve comparable results, even if the screen displays something different form that contained in FIG. 5.

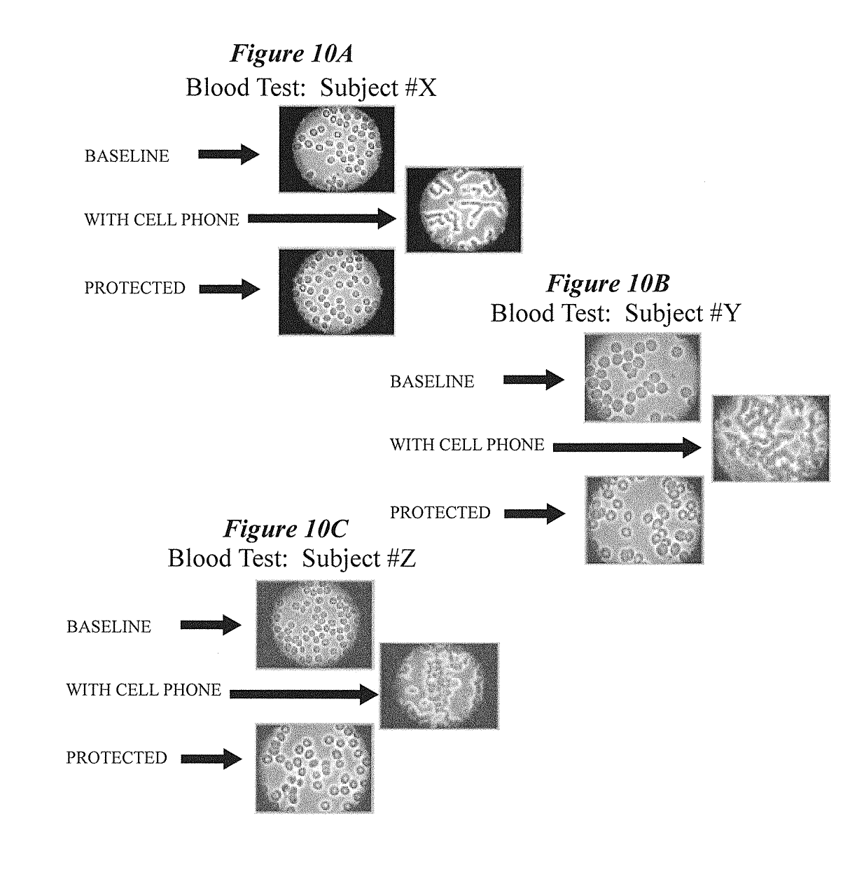

As partial substantiation to the claims here, attention is directed to FIGS. 10A through 10C which show the photomicrographs of human blood during lab tests. In each case (i.e., for both. Subjects X, Y, and Z) the top illustration in each figure shows red blood cells in advance of the subject being exposed to EMF radiation sourced by a cellular telephone. The second/right most image in each figure indicates what happens to red blood cells after a period of such exposure. Obviously, EMF radiation from the phone has had a dramatic impact on the appearance of the red bloods cells in these figures via interaction with them. Finally, the bottom image in each case contains a photomicrograph of red blood cells that were collected from the same subjects after EMF radiation via cellphone, where the phone was executing an embodiment of the instant invention during the exposure as is discussed more fully below. As can be seen, the red blood cells have returned to near normal/baseline values due to the intervention of the instant invention.

Turning to FIG. 11, this figure contains an operating logic suitable for use with an embodiment of the instant invention. In one embodiment and according to this figure, an algorithm will be selected (1100) and loaded (1110) onto the computing device of choice. The algorithms referred to would include, for example, execution of one or more of the equations presented above to create some number of the elements 10 in connection with formation of a pattern such as those illustrated in FIGS. 1-3, and drawing the resulting image (e.g., in the form of FIGS. 6-8) in connection with the hardware embodiment.

Next, and preferably, the selected algorithm will be executed 1120 by the CPU(s) of the device on which the algorithms were loaded. Preferably, this device will have a display screen, but it could be that such is not available, in which case the logic discussed below will handle that condition.

Next, in an embodiment, a determination will be made as to whether or not the screen is accessible (step 1130). If the answer is “YES” (the left branch of decision item 1130), the simulated array will be drawn on that screen and the algorithm will branch to step 1130 for further processing. According to some embodiments, the application might write to the display a low contrast (e.g., translucent or semi-translucent) version of the pattern in such a way that it will overlaying the current screen display but not substantially interfere with it.

On the other hand, if the screen is not available (e.g., it is being used for other purposes or the device on which the algorithm is executing has no such display, for example a WiFi router, radio receiver/transmitter), the instant invention will execute the selected algorithm (from step 1100) and write the simulated array into memory. After that is done, the instant invention will return to step 1120 for further processing.

Finally, it should be noted that the instant invention might be implemented on or within, or attached or made proximate to any conventional or unconventional computing (programmable) device such as, by way of example and without limitation, a desk top computer, a cell phone, a lap top, a table top computer, a car video display, a medical workstation, medical diagnostic equipment, a home television, an MP3 player, Google® Glasses, or any other device that has a display screen (e.g., a refrigerator, a game controller, a treadmills, an automobile console, a cash register, a slot machine, etc.). Preferably, the device on which the instant invention will be implemented will have a display device or screen of some sort, although that is not a requirement as described supra.

The substrate 12 could potentially comprise any nonconductive material including, without limitation, plastic, cellulose pulps, metals, textiles, fabrics, polymers, ceramics, organic fibers, silicon, and composites, as specific examples. In particular, the substrate may be incorporated into and/or include a portion of an article of clothing or garment.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

Note that when the terms “computer”, “computing device”, “CPUs”, etc., are used herein these terms should be broadly interpreted to include any programmable device whether a consumer electronics product (e.g., personal computer, smart phone, tablet, etc.) or an electronic appliance or other device that has a programmable chip (e.g., microprocessor, micro controller, etc.) integral thereto.

Further, it should be noted that when the term “spiral array element” or “spiral” is used herein, unless specifically indicated to the contrary that should be interpreted to require a non-logarithmically expanding spiral form that has at least three turns, but preferably six “turns”. FIG. 14 contains an illustration of how “turns” are determined according to the instant disclosure. In that figure, a line has been drawing between the starting and ending points of the spiral 1400. Each dot in that figure represents a “one turn” and, as it indicated in this drawing, counting both the starting and ending points there are six turns in the spiral 1400.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. An antenna array comprising:
a. a substrate; and,
b. three or more conductive spiral array elements symmetrically arrayed and present on said substrate, each of said three or more array elements having a form defined by an equation in the coordinates x and y:
$$x = + {\int }_{0}^{A} cos ( \frac{π}{2} {s}^{2} ) d s$$
$$y = - {\int }_{0}^{A} sin ( \frac{π}{2} {s}^{2} ) d s$$
where, A is a length of the curve as measured from the origin, and where A is chosen such that each of said three or more array elements has at least six turns,
where s is a parameter of integration measured in radians,
π is a constant which is approximately equal to 3.14, and,
wherein a number of said three or more array elements is a multiple of either two or three.

2. The antenna array according to claim 1, wherein each of said array elements is comprised of a material selected from the group consisting of gold, silver, copper, aluminum, and carbon.

3. The antenna array according to claim 1, wherein said substrate is made of a material selected from the group consisting of plastic, cellulose pulps, textiles, fabrics, polymers, ceramics, organic fibers, silicon, and composites.

4. An antenna array comprising:
a. a substrate; and,
b. three or more conductive spiral array elements symmetrically arrayed and present on said substrate, each of said three or more array elements having a form defined by an equation in the polar coordinates as
r=aθ,
where r is a distance from an origin and θ is an angle of rotation chosen such that each of said spiral array elements has at least six turns, and a is an arbitrary constant, and,
wherein a number of said three or more array elements is a multiple of either 2 or three.

5. The antenna array according to claim 4, wherein each of said array elements is comprised of a material selected from the group consisting of gold, silver, copper, aluminum, and carbon.

6. The antenna array according to claim 4, wherein said substrate is made of a material selected from the group consisting of plastic, cellulose pulps, textiles, fabrics, polymers, ceramics, organic fibers, silicon, and composites.

7. An antenna array comprising:
a. a substrate; and,
b. three or more conductive spiral array elements symmetrically arrayed and present on said substrate, each of said three or more array elements having a form defined by an equation in the polar coordinates as
r=aθ,
where r is a distance from an origin and θ is an angle of rotation chosen such that each of said spiral array elements has at least six turns, and a is an arbitrary constant, and,
wherein a number of said three or more array elements is a multiple of either two or three.

8. The antenna array according to claim 7, wherein each of said array elements is comprised of a material selected from the group consisting of gold, silver, copper, aluminum, and carbon.

9. The antenna array according to claim 7, wherein said substrate is made of a material selected from the group consisting of plastic, cellulose pulps, textiles, fabrics, polymers, ceramics, organic fibers, silicon, and composites.

10. An antenna array comprising:
a. a substrate; and,
b. three or more conductive spiral array elements symmetrically arrayed and present on said substrate, each of said three or more array elements having a form defined by the equation in the polar coordinates as
r²=a²θ,
where r is a distance from an origin and θ is an angle of rotation chosen such that each of said spiral array elements has at least six turns, and a is an arbitrary constant, and,
wherein a number of said three or more array elements is a multiple of either two or three.

11. The antenna array according to claim 10, wherein each of said array elements is comprised of a material selected from the group consisting of gold, silver, copper, aluminum, and carbon.

12. The antenna array according to claim 10, wherein said substrate is made of a material selected from the group consisting of plastic, cellulose pulps, textiles, fabrics, polymers, ceramics, organic fibers, silicon, and composites.

13. A method of attenuating low intensity EMF radiation in a computing device having a display integral thereto, comprising the steps of:
within said computing device,
a. forming a graphical representation of a symmetric antenna array comprised of at least three non-logarithmically expanding spirals,
wherein each of said spirals has at least six turns,
wherein each of said three or more has at least six turns,
and wherein a number of said three or more array elements is a multiple of either two or three; and,
b. displaying said graphical representation on said display.

14. The method according to claim 13, wherein said written graphical representation is translucent or semi-translucent on said display.

15. The method according to claim 13, wherein each of said at least three non-logarithmically expanding spirals has a form selected from the group consisting of
a spiral of Cornu being defined by an equation in the coordinates x and y:
$$x = + {\int }_{0}^{A} cos ( \frac{π}{2} {s}^{2} ) d s$$
$$y = - {\int }_{0}^{A} sin ( \frac{π}{2} {s}^{2} ) d s$$
where, A is a length of the curve as measured from the origin, and where A is chosen such that each of said three or more array elements has at least six turns,
where s is a parameter of integration measured in radians, and,
π is a constant which is approximately equal to 3.14;
an Archimedes spiral being defined by an equation in polar coordinates as
r=aθ,
where r is a distance from an origin and θ is an angle of rotation chosen such that each of said spiral array elements has at least six turns; and,
a Fermat's spiral being defined by an equation in polar coordinates as
r²=a²θ,
where r is a distance from an origin and θ is an angle of rotation chosen such that each of said spiral array elements has at least six turns, and a is an arbitrary constant.
